(19) United States
(12) Patent Application Publication
(10) Pub. No.: US 2011/0096022 A1
(43) Pub. Date: Apr. 28, 2011

(54) SYSTEM AND METHOD FOR TOUCH PANEL HOTKEY FUNCTION

(75) Inventor: KUAN-NENG WANG, Tu-Cheng (TW)

(73) Assignee: HON HAI PRECISION INDUSTRY CO., LTD., Tu-Cheng (TW)

(21) Appl. No.: 12/837,432

(22) Filed: Jul. 15, 2010

(30) Foreign Application Priority Data
Oct. 28, 2009 (CN) 200910308995.7

(51) Int. Cl. G06F 3/045

(52) U.S. Cl. 345/174

(57) ABSTRACT

A hotkey management system and a method executes hotkey function of an electronic device having a touch panel. The system can define a number of virtual blocks of the touch panel and divide a plurality of virtual block sets and set the hotkey functions corresponding to the virtual block sets. Different combination of virtual blocks represent different hotkey functions. The user contacts some virtual blocks of the touch panel and the virtual block set is active by analyzing the at least two coordinate values according to the contacts. The hotkey management system can execute the corresponding function according to the analyzed coordinate values.

### BACKGROUND

1. Technical Field

Embodiments of the present disclosure relate to data input, and more particularly to an electronic device and method enabling virtual hotkey functions on a touch panel of the electronic device.

2. Description of Related Art

Touch panels are utilized in many electronic devices, providing an improved input means with advantages of convenience and ease of use over typical keypad-style input. However, some functions can only be enabled by execution of complicated gestures, which, if unclearly executed, prevent the device from properly recognizing the input.

Accordingly, what is needed is a touch panel overcoming the limitations described.

### BRIEF DESCRIPTION OF THE DRAWINGS

FIG. 1 is a block diagram of one embodiment of a hotkey management system using an electronic device.

FIG. 2 is a schematic diagram of the hot key management system of FIG. 1 defining three virtual blocks on the touch panel.

FIG. 3 is a schematic diagram of the hot key management system of FIG. 1 defining four virtual blocks on the touch panel.

FIG. 4 is a flowchart illustrating one embodiment of a method for enabling hotkey management system using an electronic device.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

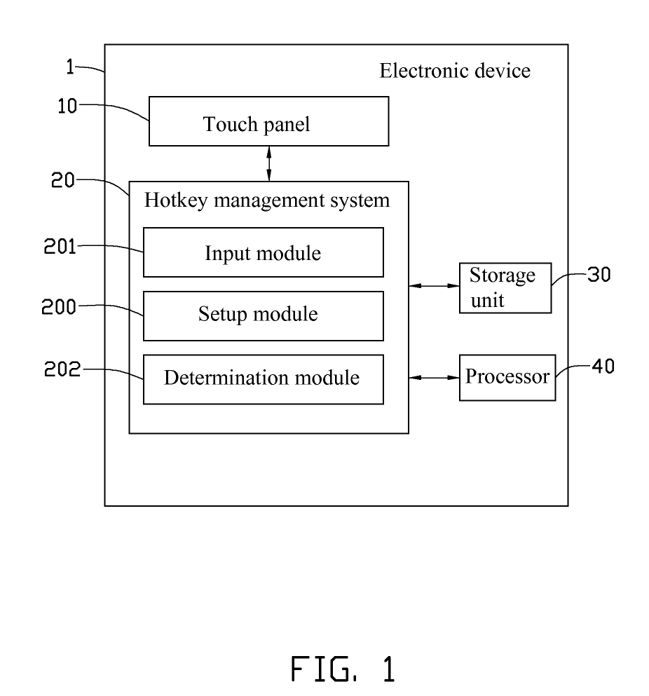

FIG. 1 is a block diagram of one embodiment of an electronic device 1 comprising a hotkey management system 20. The electronic device 1 includes a touch panel 10, a hotkey management system 20 a storage unit 30 and a processor 40. The electronic device 1 is operable to enable virtual hotkey functions by detecting multiple contacts on the touch panel 10 using the hotkey management system 20.

The electronic device 1 is generally controlled and coordinated by operating system software, such as the UNIX, Linux, Windows 95, 98, NT, 2000, XP, Vista, Mac OS X, an embedded operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The touch panel 10 is operable to detect at least one contact (e.g., a finger) on the touch panel 10 and generate at least one coordinate value of the at least one contact on the touch panel 10 to the hotkey management system 20. In one embodiment, the user can contact the touch panel 10 using multiple simultaneous contacts. For example, the touch panel 10 can detect one or more contacts in two or three locations on the touch panel 10 at the same time to generate two or three coordinate values of the one or more contacts to the hotkey management system 20. In some embodiments, a stylus can be used with the touch panel 10.

The storage unit 30 is electronically connected to the touch panel 10, the hotkey management system 20, and the processor 40. The storage unit 30 is operable to store many kinds of data, such as a customization function code of the electronic device 1, computerized codes of the hotkey management system 20, programs of an operating system and other applications of the electronic device 1. The storage unit 30 may include a hard disk drive, flash memory, RAM, ROM, cache, or external storage mediums.

The processor 40 is operable to execute one or more computerized codes of the hotkey management system 20 may be stored in the storage unit 40 and executed by the processor 40. The processor 40, as an example, may include a CPU, math coprocessor, shift register, and so on.

The hotkey management system 20 includes a setup module 200, an input module 201, and a determination module 202. The hotkey management system 20 is configured to connect to the touch panel 10, the storage unit 30 and the processor 40. The hotkey management system 20 is operable to enable virtual hotkey functions by multiple contacts on the touch panel 10 using the electronic device 1.

The setup module 200 is operable to define a number of virtual blocks of the touch panel and combining at least two virtual blocks to set a plurality of virtual block sets. The virtual blocks are blocks that divide several parts of the touch panel by separation lines. The amount of separation lines is determined by the number defined from the setup module 200. For example, if the setup module 200 defines a number 2 of the virtual blocks, the setup module 200 defines one separation line to generate two virtual blocks on the touch panel. In addition, the setup module 200 is operable to set hotkey functions corresponding to each of the virtual block sets and save the information, such as the number of virtual blocks, virtual block set and hotkey functions, to the storage unit 30.

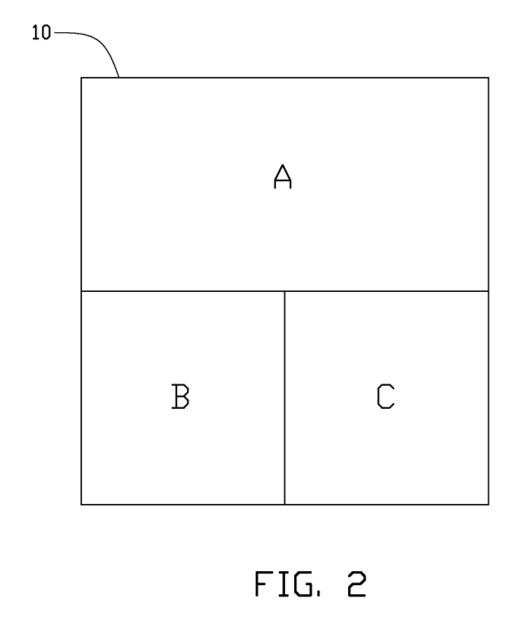

FIG. 2 is a schematic diagram of the hot key management system 20 of FIG. 1 defining three virtual blocks on the touch panel 10. As shown, the setup module 200 defines three virtual blocks (block A, block B and block C) on the touch panel 10. The setup module 200 then sets a plurality of virtual block sets by combining at least two virtual blocks from the three virtual blocks. For example, the setup module 200 sets a block set (block set AB) by combining block A and block B. In addition, the setup module 200 sets different hotkey functions corresponding to each of the virtual block sets and saves them to the storage unit 30. In one embodiment, the setup module 200 sets a copy function as the hotkey function by combining block A with block C. In other embodiments, the setup module 200 sets a delete function as the hotkey function by combining block B with block C. In other embodiments, the setup module 200 sets a paste function as the hotkey function by combining block A, block B with block C.

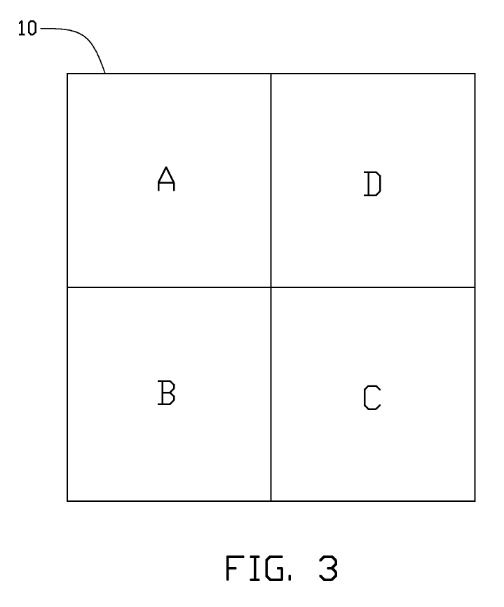

FIG. 3 is a schematic diagram of the hot key management system of FIG. 1 defining four virtual blocks on the touch panel 10. As shown, the setup module 200 defines four virtual blocks (block A, block B, block C and block D) on the touch panel 10. The setup module 200 then sets a plurality of virtual block sets by combining at least two virtual blocks from the four virtual blocks. In addition, the setup module 200 sets different hotkey functions corresponding to each of the virtual block sets and saves them to the storage unit 30. In one embodiment, the setup module 200 can set hotkey functions for music when the electronic device 1 is in a music mode. For example, the setup module 200 sets a play function as the hotkey function by combining block A, block B with block C and sets a stop function as the hotkey function by combining block A, block B, block C with block D. In other embodiments, when the electronic device 1 is in a camera mode, the setup module 200 sets a capture function as the hotkey function by combining block B, block C with block D and sets an image saving function as the hotkey function by combining block A, block B, block C with block D. Furthermore, the user is able to define more virtual blocks on the touch panel 10 for different requirements in programs installed in the electronic device 1. For example, Bluetooth transferring program or game in the electronic device 1.

The input module 201 is operable to detect the multiple contacts on the touch panel 10 and generate at least two coordinate values according to touch locations of the multiple contacts on the touch panel. For example, the touch panel 10 can be contacted in two simultaneous locations, causing the input module 201 to detect the multiple contacts from the touch panel 10 and generates two coordinate values to the determination module 202.

The determination module 202 is operable to determine the virtual block set by analyzing the at least two coordinate values from the input module 201. In one embodiment, the determination module 202 analyzes whether the location of coordinate value is within a specific range of the virtual block. If so, the virtual block is operational and active. Repeating the process, the determination module 202 continuously analyzes locations of the coordinate values from the input module 201 and determines the virtual block sets in operation.

The processor 40 determines if the virtual block set in operation corresponds to the virtual block set saved in the storage unit 30. If so, the processor 40 executes the corresponding hotkey function saved in the storage unit 30.

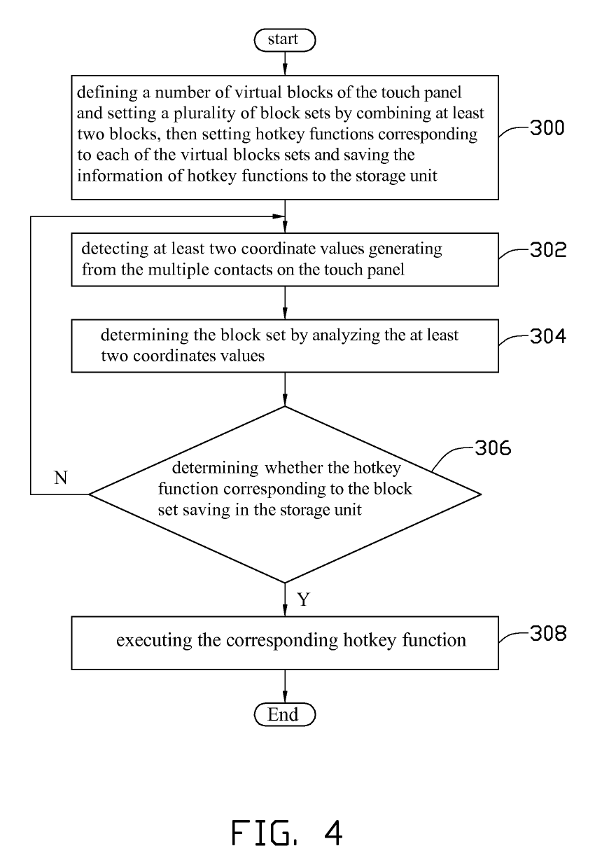

FIG. 4 is a flowchart illustrating an embodiment of a method for enabling hotkey management system on an electronic device. Depending on the embodiment, additional blocks may be added, others deleted, and the ordering of blocks may be changed.

In block S300, the setup module 200 defines a number of virtual blocks of the touch panel 10 and sets a plurality of virtual block sets by combining at least two virtual blocks. The setup module 200 then sets hotkey functions corresponding to each of the virtual block sets and saves the hotkey functions to the storage unit 30.

In block S302, the input module 201 detects the multiple contacts on the touch panel and generates at least two coordinate values according to touch locations of the multiple contacts on the touch panel;

In block S304, the determination module 202 determines the virtual block set by analyzing the at least two coordinate values

In block S306, the processor 40 determines whether the virtual block set receiving from the determination module 202 corresponds to the virtual block set saved in the storage unit 30. If so, block S308 is implemented and the processor 40 executes the hotkey function corresponding to the virtual block set saved in the storage unit 30. If not, block 302 is implemented and the multiple contacts on the touch panel are still detected.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A hotkey management system using an electronic device, the electronic device comprising a processor, a storage unit storing information and a touch panel receiving multiple contacts, the system comprising:
a setup module operable to define a number of virtual blocks of the touch panel, set a plurality of virtual block sets by combining at least two of the virtual blocks, set hotkey functions corresponding to each of the virtual block sets and save the hotkey functions to the storage unit;
an input module operable to detect the multiple contacts on the touch panel and generate at least two coordinate values according to touch locations of the multiple contacts on the touch panel; and
a determination module operable to determine the virtual block set by analyzing the at least two coordinate values.

2. The system of claim 1, wherein contact is made by fingers or a stylus.

3. The system of claim 1, wherein the number of virtual blocks is at least three.

4. The system of claim 1, wherein the multiple contacts are made on the touch panel by fingers.

5. The system of claim 1, wherein the touch panel is a capacitive panel.

6. The system of claim 1, wherein the touch panel is a resistive panel.

7. A method for enabling hotkey management system on an electronic device, the electronic device comprising a processor, a storage unit storing information and a touch panel receiving multiple contacts, the method comprising:
defining a number of virtual blocks of the touch panel;
setting a plurality of virtual block sets by combining at least two virtual blocks;
setting hotkey functions corresponding to each of the virtual block sets;
saving information of the hotkey functions to the storage unit;
detecting at least two coordinate values generated from the multiple contacts on the touch panel;
determining the virtual block set by analyzing the at least two coordinate values; and
executing the corresponding hotkey function if the hotkey function corresponding to the virtual block set saved in the storage unit.

8. The method of claim 7, wherein the contact is made by fingers or a stylus.

9. The method of claim 7, wherein the number of the virtual blocks is at least three.

10. The method of claim 7, wherein the multiple contacts on the touch panel are by two fingers.

11. The method of claim 7, wherein the touch panel is a capacitive panel.

12. The method of claim 7, wherein the touch panel is a resistive panel.

13. A storage medium having stored thereon instructions that, when executed by a processor, causes the processor to perform a method for enabling hotkey management system on an electronic device, the electronic device comprising a processor, a storage unit storing information and a touch panel receiving a multiple contacts, the method comprising:
define a number of virtual blocks of the touch panel;
set a plurality of virtual block sets by combining at least two virtual blocks;
set hotkey functions corresponding to each of the virtual block sets;
save information of the hotkey functions to the storage unit;
detect at least two coordinate values generating from the multiple contacts on the touch panel;
determine the virtual block set by analyzing the at least two coordinate values; and
execute the corresponding hotkey function if the hotkey function corresponding to the virtual block set saved in the storage unit.

14. The storage medium of claim 13, wherein contact is made by fingers or a stylus.

15. The storage medium of claim 13, wherein the number of the virtual blocks is at least three.

16. The storage medium of claim 13, wherein the multiple contacts on the touch panel are made by fingers.

17. The storage medium of claim 13, wherein the touch panel is a capacitive panel.

18. The storage medium of claim 13, wherein the touch panel is a resistive panel.
